(19) United States
(12) Patent Application Publication
(10) Pub. No.: US 2004/0124151 A1
(43) Pub. Date: Jul. 1, 2004

(54) Fibrous protein adsorption of heavy metals

(75) Inventors: Carlo Licata, Pasadena, CA (US); Rajendra Mehta, Reno, NV (US); Manorangan Misra, Reno, NV (US)

Correspondence Address: PAUL, HASTINGS, JANOFSKY & WALKER LLP, P.O. BOX 919092, SAN DIEGO, CA, 92191-9092, US

(73) Assignee: MAXIM, LLC, a limited liability corporation

(21) Appl. No.: 10/600,278

(22) Filed: Jun. 20, 2003

Related U.S. Application Data
(63) Continuation-in-part of application No. 09/876,663, filed on Jun. 6, 2001, now Pat. No. 6,685,838.
(60) Provisional application No. 60/255,220, filed on Dec. 12, 2000.

(51) Int. Cl. C02F 1/28

(52) U.S. Cl. 210/661; 210/688

(57) ABSTRACT

A method of removing a heavy metal from a composition comprises: (1) providing a fibrous protein fiber; (2) agitating the fibrous protein fiber; (3) making a slurry of the agitated fibrous protein fiber; (4) contacting the agitated fibrous protein fiber slurry with a composition containing a heavy metal ion or a heavy metal ion complex; and (5) filtering a supernatant produced in step (4) to remove the heavy metal from the composition. The fibrous protein of the fibrous protein fiber can be selected from the group consisting of keratins, collagens, fibrins, and elastins. Typically, the fibrous protein of the fibrous protein fiber is a keratin. Yet another aspect of the present invention is a method of removing a heavy metal from a composition, comprising: (1) providing a keratin protein fiber; (2) agitating the keratin protein fiber by a process selected from the group consisting of ultrasound and mechanical mixing; (3) treating the keratin protein fiber with alkali at a pH of between about 9 to about 14; (4) packing the agitated alkali treated keratin protein fiber into a column; (5) passing the composition through the column under pressure to remove the heavy metal from the composition; (6) desorbing adsorbed heavy metal from the column by treatment with an acid; (7) washing the column for a first time; (8) regenerating the column by passing alkali through the column; and (9) washing the column for a second time.

### CROSS-REFERENCE TO RELATED APPLICATIONS

This application is a continuation-in-part of application Ser. No. 09/876,663 by Mehta et al., entitled “Keratin Protein Adsorption of Heavy Metals,” filed Jun. 6, 2001, the contents of which are hereby incorporated in their entirety by this reference, which in turn claimed the benefit of U.S. Provisional Application No. 60/255,220, filed Dec. 12, 2000.

### BACKGROUND OF THE INVENTION

The present invention generally relates to the adsorption of heavy metals and, more particularly, to the adsorption of heavy metals such as Cs and Sr by fibrous proteins, particularly by keratin protein such as that found in feather fibers.

In a multitude of applications and environments, there is often a need to remove contaminants from solids, liquids, and gases. Those contaminants may be in one of many forms, including heavy metal ions and complexes of heavy metal ions with chloro or cyano ions. As one example, the U.S. Department of Energy (DOE) has generated large volumes of high-level radioactive water waste (HLW) from the reprocessing of spent uranium. The HLW contains significant levels of radioactive strontium (Sr) and cesium (Cs). The HLW is stored in stainless steel tanks underground. The HLW has been made highly alkaline (about pH 13) so as to not attack the tank material and leach through the walls. The high alkalinity of the material causes it to range in temperature between about 25 to 93° C. in the tanks.

The tanks can leak over time and cause radioactive environmental cleanup issues. For reasons of safety, the DOE wants to remove the HLW from the tanks and close the storage site. To date, the systems proposed to reduce the levels of Sr and Cs are expensive or capital intensive, with each having problems with them. For example, ion exchange resins have been evaluated in the environment. They, however, tend to be very expensive and to increase significantly in volume under use. A DOE report entitled “Electrochemical Treatment of Alkaline Nuclear Wastes” (DOE Report DOE/EM-0560) (January 2001), describes a process that electrochemically converts aqueous sodium nitrate/nitrite into sodium hydroxide and then chemically reduces the nitrogen species to gaseous ammonia, nitrous oxide, and nitrogen. This process is complex and capital intensive.

Other processes for removal of heavy metals are described and compared in Table 1.

TABLE 1
SUMMARY OF PHYSICAL AND CHEMICAL
PROCESSES FOR HEAVY METAL REMOVAL

| PROCESS | DESCRIPTION | COMMENTS |
|---|---|---|
| Activated | Species removed | Sometimes ineffective process |
| Carbon | mainly by hydrophonic | sensitive to suspended solids |
| | adsorption. | and oils. |
| | | Problems of disposal and/or |
| | | regeneration of spent carbon. |
| | | Adsorption of several inorganic |
| | | species like: Ae, Cr, Ag, Co, I, |
| | | Sm, Zn, B. |
| Ion | Ions removed by | High capital and operating |
| Exchange | exchange or resin, | costs. |
| | replaced by harmless | Well-established technology. |
| | ions from the resin. | |
| Solvent | Extraction of metal ions | High capital and operating |
| Extraction | from aqueous solution | costs. |
| | by chelating agents in | Well-established technology. |
| | non-polar solvents. | |
| Micro/nano/ | Elimination of metal | High capital and operating |
| ultra- | precipitates and other | costs. |
| filtration | pollutants by | Extensive membrane or |
| | permeation through | filtering media preparation: |
| | membranes or other | Solids, microorganisms, oil |
| | filtering media. | and grease removal, etc. |
| Reverse | Elimination of metal | High capital and operating |
| osmosis | ions by permeation | costs. |
| | through membranes. | Pretreatment necessary to |
| | | avoid problems with fouling, |
| | | plugging and chemical |
| | | attachment. |
| | | Extensive membrane |
| | | preparation: Solids, |
| | | microorganisms, oil and |
| | | grease removal, etc. |
| Biosorption | Adsorption or | Low cost technology. |
| | absorption of the heavy | Suitable as a polishing stage. |
| | metals onto biomass. | Technology not completely |
| | | established. |
| | | Biodegradable. |

Despite the availability of the methods recited in Table 1, the removal of heavy metals and toxic chemicals from dilute solutions generated from different industrial sources is a challenging job. Numerous manufacturing industries and large operations discharge a variety of process waters containing heavy metals into the environment. It is estimated that the cost for environmental control of the such toxic heavy metals was around $280 billion in 1995 and will increase to $680 billion by 2010.

In recent years biotechnological processes for environmental remediation have drawn significant attention. Biosorption processes are environmentally friendly and are low cost in operation. Materials that can be used for biosorption of heavy metals include microorganisms, chitosan, peat moss, and plant biomass.

Keratin protein derived from natural sources has been shown to have an affinity for heavy metals (Tratnyek, J. P., “Waste Wool as a Scavenger for Mercury Pollution in Waters”, Environmental Protection Agency, U.S. Printing Office, Washington, D.C., 1972). Keratin is a sulfur containing protein that may be found in epidermal outgrowths, such as feathers, horns, hooves, hair, and wool. Given the naturally occurring and abundant sources of keratin, much interest has focused on its use for adsorbing metals, whether for eventual recovery or disposal.

In particular, keratin protein derived from chicken feathers has been used to adsorb gold, platinum, and palladium at an optimum pH between about 1 to 3. Suyama et al., “Biosorption of Precious Metal Ions by Chicken Feathers,” Applied Bio. and Biotech. Part A: Enzyme Eng. and Biotech. Spring 1996, 57-58:67-74. Similarly, keratin protein was used to remove rhodium, ruthenium, gold, silver, iridium, zinc, aluminum, iron, copper, nickel, and tin preferably at a pH between 2 to 3 in U.S. Pat. No. 4,289,531. Maximum adsorption of gold-cyanide by chicken feathers has occurred around pH 2. Ishikawa et al., Recovery and Refining of Gold by Gold Cyanide Ion Biosorption Using Animal Fibrous Proteins, Applied Bio. and Biotech. Part A: Enzyme Eng. and Biotech. Spring 1998, 70-72:719-728.

Yet, the adsorption process by keratin protein has been found to be slow, somewhat limited in adsorption capacity in comparison to other adsorbents, and dependent upon a low pH. It is also generally accepted that naturally occurring keratin fibers have poor resistance to alkali treatment and can lose much of their mechanical strength when subjected to a high pH environment of about pH 9 to 14.

As can be seen, there is a need for a keratin protein method of adsorbing heavy metal ions, such as Cs and Sr, as well as heavy other metal ions, by a keratin protein preparation that can be used in a high pH environment of about 9 to 14 and also in a highly concentrated alkaline environment. Furthermore, there is a need for such methods that can process large volumes of contaminated aqueous solutions and that can utilize recycling of the adsorption medium for greater efficiency.

### SUMMARY OF THE INVENTION

In one aspect of the present invention, a method of removing a heavy metal from an alkaline composition comprises providing a keratin protein from a feather; treating the keratin protein with ultrasonic or the like; making a slurry of the treated keratin protein; contacting the keratin protein with the alkaline composition of heavy metal by mechanical agitation or the like; and filtering a supernatant produced in the step of contacting.

In another aspect of the present invention, a method of removing at least one of Sr and Cs from an alkaline solution having a pH between about 9 to 14 comprises providing a keratin protein from a poultry feather (or turkey, duck, etc.); making a slurry of the keratin protein and the alkaline solution; treating the slurry with ultrasound; contacting the keratin protein with at least one of Sr and Cs by mechanical agitation or the like; and filtering a supernatant produced in the step of contacting.

In a further aspect of the present invention, a method of removing both Sr and Cs from an alkaline solution having a pH between about 9 to 14 comprises providing a keratin protein from essentially a fiber portion separated from a quill portion of a chicken feather; making a slurry of the keratin protein and the alkaline solution and subjecting the slurry to ultrasound, the Sr being present in the alkaline solution at least at about 5 ppb and up to about 100,000 ppb or more and the Cs being present in the alkaline solution at least at about 5 ppb and up to about 100,000 ppb or more; contacting the keratin protein with the Sr and Cs by mechanical agitation or the like, the step of contacting occurring at a temperature between about 20 to 90° C. and a pressure not greater than about 10 psi; and filtering a supernatant produced in the step of contacting.

Another aspect of the present invention is a method of removing a heavy metal from a composition, comprising: (1) providing a fibrous protein fiber; (2) agitating the fibrous protein fiber; (3) making a slurry of the agitated fibrous protein fiber; (4) contacting the agitated fibrous protein fiber slurry with a composition containing a heavy metal ion or a heavy metal ion complex; and (5) filtering a supernatant produced in step (4) to remove the heavy metal from the composition.

The fibrous protein of the fibrous protein fiber can be selected from the group consisting of keratins, collagens, fibrins, and elastins. Typically, the fibrous protein of the fibrous protein fiber is a keratin, such as an a-keratin or a p-keratin. Typically, the keratin is a naturally-occurring keratin and is unmodified.

Preferably, the keratin is a p-keratin and is obtained from avian feathers, such as from a chicken, a turkey, a duck, or a goose.

Alternatively, the keratin is selected from the group consisting of keratin proteins obtained from wool, eggshell membrane, silk, spider web, animal hair, human hair, animal nail, human nail, animal skin, and their components.

Yet another aspect of the present invention is a method of removing a heavy metal from a composition, comprising: (1) providing a keratin protein fiber; (2) agitating the keratin protein fiber by a process selected from the group consisting of ultrasound and mechanical mixing; (3) treating the keratin protein fiber with alkali at a pH of between about 9 to about 14; (4) packing the agitated alkali treated keratin protein fiber into a column; (5) passing the composition through the column under pressure to remove the heavy metal from the composition; (6) desorbing adsorbed heavy metal from the column by treatment with an acid; (7) washing the column for a first time; (8) regenerating the column by passing alkali through the column; and (9) washing the column for a second time.

### BRIEF DESCRIPTION OF THE DRAWINGS

The following invention will become better understood with reference to the specification, appended claims, and accompanying drawings, where:

FIG. 1 is a flow diagram depicting the steps according to a method of removing heavy metals, such as Sr and Cs, according to the present invention.

FIG. 2 is a scanning electron microscope (SEM) picture of keratin protein fibers.

FIG. 3 is a SEM picture of keratin protein fiber showing the porous network.

FIG. 4 is a high magnification SEM image of keratin protein fiber showing the nanosized pores.

FIG. 5 is an atomic force microscope (AFM) picture of keratin protein fibers showing the microstructural morphology.

FIG. 6 is a SEM image of keratin quill showing the organized structure.

FIG. 7 is a SEM image of keratin quill revealing the lack of micropores.

FIG. 8 is a graph showing the zeta potential of finely ground keratin protein fiber in the presence of released calcium.

FIG. 9 is a diagram showing the structure of keratin protein fiber showing the multiple functionalities: (a) electrostatic interaction; (b) hydrogen binding; (c) hydrophobic interactions; and (d) disulfide linkages.

FIG. 10 is a flow diagram illustrating a batch adsorption process useful in methods according to the present invention.

FIG. 11 is a graph plotting the percentage of Pb remaining versus time at pH 2, pH 4, and pH 6 using keratin protein fibers at 0.2 g/l 00 mL of solution.

FIG. 12 is a graph plotting the percentage of Pb uptake versus time at pH 2, pH 4, and pH 6 using keratin protein fibers at 1.0 g/100 mL of solution.

FIG. 13 is a graph plotting the percentage of Cu uptake versus time at pH 2, pH 4, and pH 6 using keratin protein fibers at 0.2 g/100 mL of solution.

FIG. 14 is a graph plotting the percentage of Cu uptake versus time at pH 2, pH 4, and pH 6 using keratin protein fibers at 1.0 g/100 mL of solution.

FIG. 15 is a graph showing the Langmuir adsorption isotherm for copper adsorption.

FIG. 16 is a graph plotting the percentage of Cr⁺⁶ uptake versus pH for initial keratin protein fiber concentrations of 0.2 g/l 00 mL and 1.0 g/l 00 mL.

FIG. 17 is a graph plotting the uranium concentration remaining as a function of pH with no keratin protein fiber and with 0.1 g keratin protein fiber per 100 mL solution.

FIG. 18 is a bar graph showing the concentration of uranium remaining in solution as a function of the amount of keratin protein fiber used per 100 mL of solution.

FIG. 19 is a flow diagram depicting the ultrasonic treatment procedure.

FIG. 20 is a flow diagram depicting a procedure for column adsorption using fibrous protein fiber according to the present invention.

FIG. 21 is a schematic diagram depicting continuous column adsorption using fibrous protein fiber according to the present invention.

FIG. 22 is a graph plotting effluent lead concentration versus volume passed for a first cycle and for a second cycle using column adsorption with keratin protein fiber according to the present invention.

FIG. 23 is a graph showing the concentration of uranium in the effluent as a function of volume of water passed through the column.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Although the present invention is described in the context of removing heavy metals such as Sr and Cs from a solution, the scope of the present invention is not so limited. Rather, the present invention may be utilized in the context of removing heavy metals from a solid sludge. As used herein, the term “heavy metal” includes transition metals, rare earths, and other metallic elements that are undesirable in the environment. The present invention may also be used for removing other heavy metals, for example, cadmium, copper, uranium, radium, gold, silver, vanadium, manganese, cobalt, chromium, lead, mercury, nickel, and zinc. These heavy metals are generally known as pollutants and are considered dangerous to human health. Other ions, such as anions such as chloro and cyano complexes of gold, silver, and platinum, can also be removed.

In general, the present invention provides a method that is simple and low in cost for removing at least one heavy metal such as Sr and/or Cs from large volumes of alkaline compositions such as high-level radioactive water waste. A keratin protein is used for fast (e.g., within a reaction time of about 10 minutes) and high absorption capacity (e.g., up to about 200 mg/g of keratin protein, dependent upon the initial heavy metal concentration) in a high pH environment, such as about a pH between about 9 to 14 and a high temperature environment, such as between about 20 to 90° C. This is in contrast to the prior art. Unexpectedly, the keratin protein shows little loss of weight in this environment. While it is preferred that the source of the keratin protein is feather fiber, other fibrous keratin sources, such as wool; egg shell membrane; silk; spider webs; animal and human hair; animal and human nails; and animal and human skin, can be used.

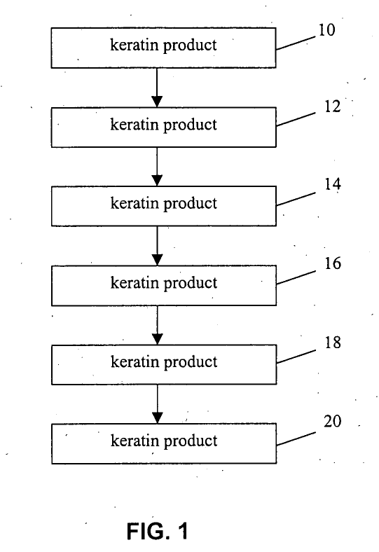

Referring to FIG. 1, a method of removing one or more metals from a composition that may be alkaline is shown in accordance with the present invention. A step 10 includes providing a keratin protein in the form of particles. Preferably, the keratin protein is from a feather, such as that of a chicken. More preferably, the keratin protein is from the fiber portion of the feather as compared to the quill portion. Thus, the keratin protein may be essentially only the fiber portion of a chicken feather that has been separated from the quill portion. What is meant by “essentially” is that the keratin protein is characterized by a fiber to quill weight ratio of at least about 1:1. The manner of preparing and then separating the fiber from the quill does not comprise a part of the present invention and may be accomplished by known methods such as that described in U.S. Pat. No. 5,705,030, incorporated herein by this reference.

The size of the keratin protein particles provided may vary from about 2 mm to 0.01 mm. Preferably, however, the size is between about 2 mm to 0.1 mm, and more preferably between about 1 mm to 0.1 mm. The keratin protein may be in the form of a powder or a fiber.

Regardless of the size or form, the keratin protein may undergo a pretreatment step 12 prior to the below steps to clean the protein particles and remove contaminants, such as solvents, that may be present from the preparation of the material in accordance with U.S. Pat. No. 5,705,030. The pre-treatment may also include opening of the micropores in the keratin particles. Further, the pre-treatment may encompass the breaking or exposing of disulfide bonds in the keratin particles to increase or maximize the ability of sulfur atoms in the keratin to bond to the heavy metal(s). The pre-treatment may generally be carried out by agitating or exciting the keratin particles, such as ultrasonically at a frequency of about 20 to 40 KHz for about 40 seconds to 5 minutes. Alternatively, the agitation or excitation may be accomplished by mechanical mixing at about 300 to 600 rpm for about 10-15 minutes. Yet another means is by UV treatment.

In step 14, the treated or agitated keratin protein from above is mixed with a composition having at least one metal ion, such as a heavy metal ion. The heavy metal composition may be in various forms, such as a solution or sludge. The number and types of metal ions may vary. However, the present invention may be particularly useful for the adsorption of Sr and/or Cs. Although the present invention may be used for non-alkaline compositions, a heavy metal composition having an alkaline pH (i.e., at least about 7.0) is most useful in application for these metals. In fact, the present invention may be applicable for compositions up to a pH between about 9 to 14 and, indeed, have greater applicability at a pH range between about 12 to 14 for removal of these metals.

Upon mixing the treated keratin protein and heavy metal composition, a slurry composition such as a solution is made in step 16. What is meant by “slurry” is a mixture of solid/liquid/feather materials. In the event the heavy metal composition from above is in the form of a sludge, an aqueous medium may be added to the mixture from step 14 to form the slurry. On the other hand, if the heavy metal composition is in the form of a solution, an aqueous medium is not needed.

The slurry may be characterized by an initial keratin protein concentration and/or an initial heavy metal concentration. While these concentrations may vary, the present invention contemplates an initial keratin protein concentration between about 0.1 to 10 mg/mL, although it can be altered for a particular application. Preferably, the keratin protein concentration is between about 1 to 2 mg/mL and, more preferably, about 2 mg/mL. The initial heavy metal concentration for a single metal may vary from at least about 5 ppb and up to about 100,000 ppb and more. Preferably, the initial heavy metal concentration is between about 10 to 300 ppb, and more preferably between about 10 to 100 ppb.

Next, in step 18, the keratin protein is contacted with the heavy metal(s) in order to mix the keratin protein with the heavy metal composition and allow the heavy metal(s) to be adsorbed by the keratin protein. This can be achieved by means such as mechanical agitation of the slurry. The mechanical agitation can be as simple as mechanical shaking of a vessel. In such case, the mechanical agitation may occur over a period of about 30 sec to 10 minutes when the slurry is of a volume between about 500 to 1000 cc. In practice, ultrasound may be alternatively employed to increase the heavy metal adsorption as the initial concentration of keratin protein in the slurry is increased. In that case, the ultrasound may occur over a period of about 30 seconds to 5 minutes at about 20 to 45 KHz when the slurry is a volume between about 500 cc to 5 liters.

As detailed below, the pH at which step 18 is performed can be varied depending on the heavy metal to be removed. As indicated above, the optimum pH for the removal of strontium and cesium is from about 9 to about 14, preferably from about 12 to about 14. Other metals have different pH optima for this step. For example, the optimum pH for the removal of lead is about 6. The optimum pH for the removal of copper is about 6. The optimum pH for the removal of cadmium is about 8.3. The optimum pH for the removal of mercury is about pH 2.0. The optimum pH for the removal of zinc is about pH 8.3. The optimum pH for the removal of chromium as Cr⁺⁶ is about 2.0. The optimum pH for the removal of nickel is about 6.2. The optimum pH for the removal of uranium is about 6. The optimum pH for the removal of other metals can be readily determined. This pH must be distinguished from the pH for the formation of the slurry, although the two pH values can be the same and typically are for the removal of strontium or cesium.

Although the temperature at which step 18 is carried out is not crucial to accomplishing step 18, the present invention enables the adsorption of heavy metals to occur at a relatively high temperature environment. Accordingly, the step 18 of contacting may occur at a temperature in excess of about 20° C. and up to about 90° C. However, it should be understood that step 18 may be carried out at lower temperatures, if desired.

Likewise, step 18 may be carried out at various pressures. However, the regulation of pressure may result in decrease or increase in adsorption. Accordingly, a typical pressure during step 18 may be not more than about 10 psi and is preferably atmospheric pressure.

Following step 18, a step 20 of filtering the slurry may be employed. Doing so can separate a supernatant of keratin protein with adsorbed metal ions from the remainder of the slurry. Filtration can occur by well-known methods such as pressure and/or vacuum. Thereafter, the supernatant may be then be vitrified, for example, with cements, glasses, and polymer based binders, for disposal.

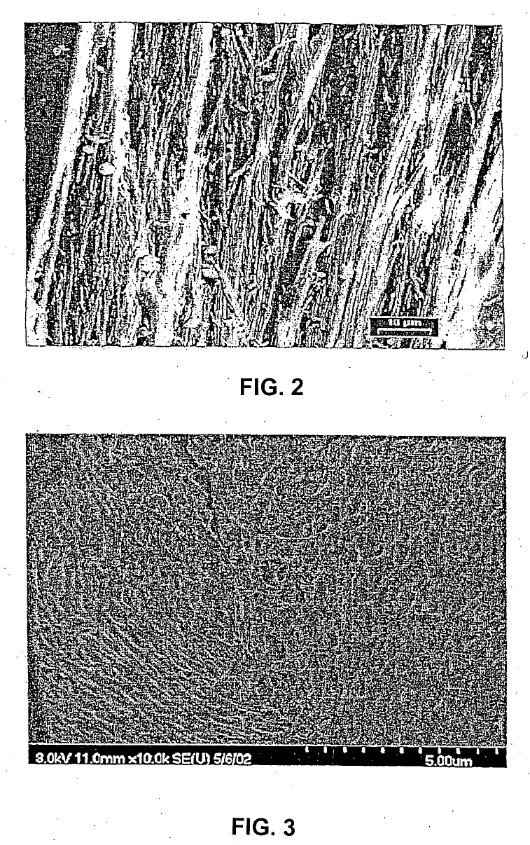

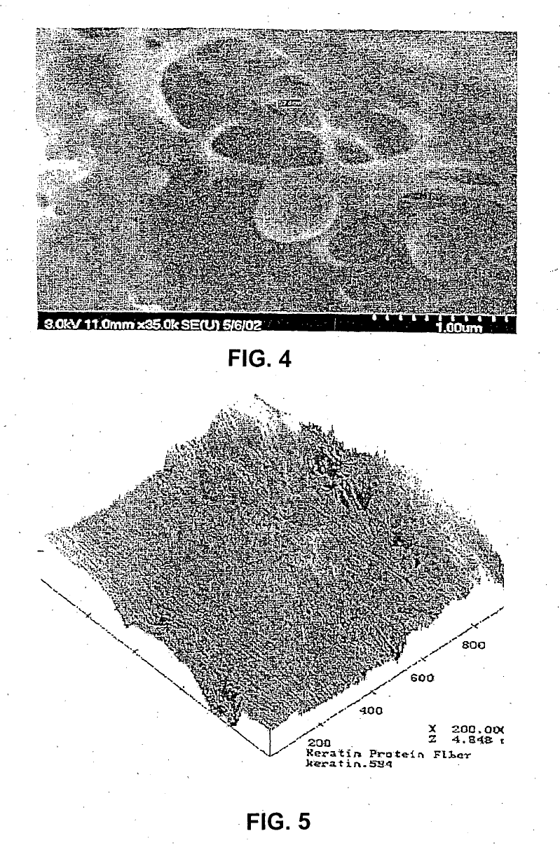

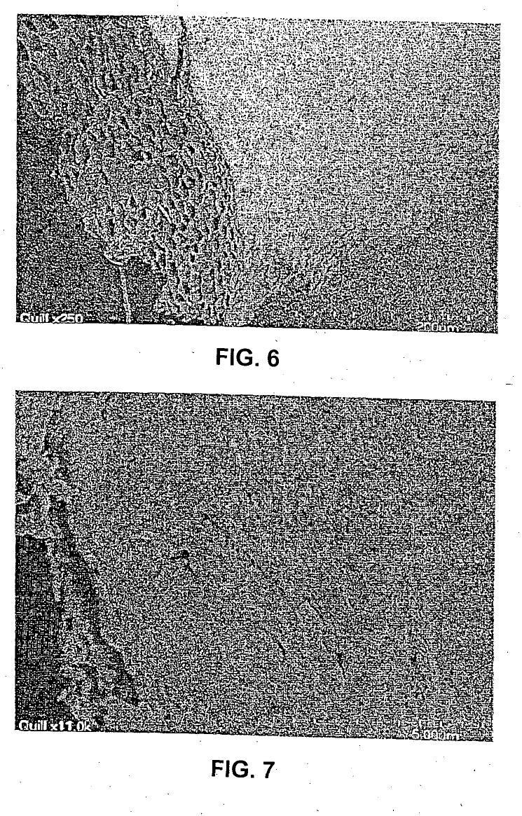

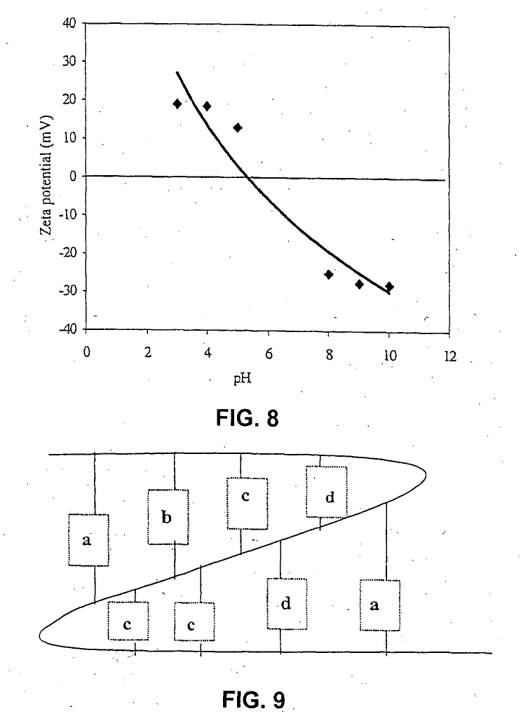

Keratin protein fibers have an intricate network of connective fibrous structure. A scanning electron microscope (SEM) picture of keratin protein fibers is shown in FIG. 2. The length of a single keratin fiber is approximately 200 microns and the maximum diameter of the fiber is 25 to 50 microns. The fiber fraction of the feather material has an organized microstructure and a nano-porous network with pores in the size range of 0.05 to 0.1 microns as shown in FIGS. 3 and 4. FIG. 3 is a SEM picture of keratin protein fiber showing the porous network, while FIG. 4 is a high magnification SEM image of keratin protein fiber showing the nanosized pores. An atomic force microscope (AFM) picture of keratin protein fibers, showing the microstructural morphology, is shown in FIG. 5 and shows that the dimension of the fibers is in the nanoscale range. The high resolution AFM picture shows that each fiber is composed of numerous fine fibrous strands. Quill is hard and has an organized structure as shown in the SEM image of FIG. 6. However, it lacks the micropores (except in the detached cross-section) found in the fiber as indicated by the SEM image of FIG. 7. The surface area of keratin protein fiber, as determined by BET, is around 11 m²/g. Fourier Transform Infrared Spectroscopic (FTIR) analysis confirmed the presence of C—H (3076.065 cm⁻¹), COOH (1653.487 and 1637.178 cm⁻¹), N—H (1540.583 cm⁻¹), C—S (1075.980 and 1073.819 cm⁻¹) and S═S (617.715 cm⁻¹) groups in the keratin fibers. This combination of nanofibrous structures and the active functional groups present make the protein fiber an excellent biosorptive material. The zeta potential of the keratin fiber as a function of pH in the presence of released calcium is shown in FIG. 8. At a pH above 5, the keratin protein is negatively charged, and at acidic pH it is positively charged. This behavior of keratin protein is due to the presence of various acidic and basic functional groups.

Amino acid analysis of the keratin fiber revealed a characteristic abundance of cysteine residues (7-20% of the total amino acid residues). These cysteine residues are oxidized to give inter- and intra-molecular disulfide bonds, which create the mechanically strong three-dimensionally linked network of keratin fiber. Each polypeptide chain in the feather keratin has a central helical section with a less regular region at each end. It has cross-linking hydrogen bonds formed between two parts of the protein chain that can be far apart. FIG. 9 illustrates schematically some of the functional groups present in the helical structure of the keratin protein and their resulting interactions: (a) electrostatic interactions; (b) hydrogen bonding; (c) hydrophobic force; and (d) disulfide linkages. These functional groups and the hollow fibrous structure contribute to the strong metal binding capacity for filtration of heavy metals.

The combination of nano-fibrous structure and functional groups makes protein fibers an excellent biosorption material.

The structure and properties of keratins are described in D. Voet & J. G. Voet, “Biochemistry” (2d ed., John Wiley & Sons, New York, 1995), pp. 153-155, incorporated herein by this reference. Keratins are divided into two classes, α-keratins and β-keratins. The α-keratins are found in mammals, and the β-keratins are found in birds and reptiles.

Methods according to the present invention can be performed with keratins obtained from avian feathers, including poultry such as chicken, turkey, duck, and goose, and other commercially available poultry species, as well as feathers from other birds such as pigeons. Alternatively, methods according to the present invention can be performed with keratins obtained from other sources such as wool, egg shell membrane, silk, spider web, animal hair, human hair, animal nail, human nail, animal skin, and human skin, or their components. As used herein, the term “keratin” includes both naturally-occurring keratin and keratin that has been modified by reactions such as acetylation, phosphorylation, hydroxylation, glycosylation, and other chemical reactions that can occur on the functional groups of the keratin proteins. As used herein, the term “keratin” further includes muteins of keratin that are produced by genetic engineering techniques well-known in the art, such as site-specific mutagenesis and fusion proteins that incorporate keratins, as long as such fusion proteins remain fibrous. However, it is generally preferable to use naturally-occurring unmodified keratins in methods according to the present invention.

Alternatively, methods according to the present invention can be performed with other fibrous proteins, either naturally-occurring fibrous proteins or chemically-modified or genetically-engineered fibrous proteins. Naturally-occurring fibrous proteins include, but are not limited to, fibroin, collagen, and elastin. Fibrous proteins are described in D. Voet & J. G. Voet, “Biochemistry” (2d ed., John Wiley & Sons, New York, 1995), pp. 153-162, incorporated herein by this reference.

Another aspect of the present invention is a column-based method of removing a heavy metal from a composition. In general, this method comprises: (1) providing a keratin protein fiber; (2) agitating the keratin protein fiber by a process selected from the group consisting of ultrasound and mechanical mixing; (3) treating the keratin protein fiber with alkali at a pH of between about 9 to about 14; (4) packing the agitated alkali treated keratin protein fiber into a column; (5) passing the composition through the column under pressure to remove the heavy metal from the composition; (6) desorbing adsorbed heavy metal from the column by treatment with an acid; (7) washing the column for a first time; (8) regenerating the column by passing alkali through the column; and (9) washing the column for a second time.

Typically, in this method, the pH of the alkali treatment step is from about 12 to about 14. Typically, the acid used for regeneration is HCl.

### EXAMPLES

### Example 1

A strontium test solution was produced by first dissolving analytical grade strontium carbonate in an acid medium. The supernatant was then transferred to an alkaline medium. The alkaline medium (i.e., waste water composition) was produced as per DOE guidelines. The composition is listed below in Table 2.

TABLE 2
Alkaline Liquid Waste Composition

| Component | Concentration |
|---|---|
| NaNO₃ | 2.6 M |
| NaOH | 13 M |
| Na₂SO₄ | 0.521 M |
| NaNO₂ | 0.134 M |
| Na₂CO₃ | 0.026 M |
| NaAl(OH)₄ | 0.429 M |
| TOTAL | 5.6 m |

The above alkaline medium contained dissolved strontium and represented a stock solution with a strontium concentration of 92.8 mg/L and a pH of about 13. One mg of stock solution was diluted to 100 mL which represented a batch test.

Feather fiber was obtained in accordance with the following method of preparation. Feathers with a total weight of 330 pounds were charged into a horizontal washer/centrifuge manufactured by Lorch, AG, of Esslingen, Germany. The feathers were then subjected to an initial hot water agitation and cleaning with 200 to 700 gallons of water heated to a temperature between 60 and 90° C., for a varying period of time. After spin-drying the feathers with the centrifugal device built into the wash machine, the dirty water effluent was discharged.

After the initial cleaning cycle above, the feathers were subjected to the second part of the cleaning cycle, which required the inclusion of a surfactant and bactericide to the same amount of water and the same temperature and times ranges described above. The surfactant and the bactericide/anti-microbial were combined (i.e., Mixxocydin) and utilized at the rate of one to six percent of the wash-water. After completion of this wash cycle, the centrifugal spin cycle was repeated. A final rinse with water alone was effected, and after the final spin, the clean but still wet feathers were discharged to the feather drying system.

The dryer/after-cooler system, also manufactured by Loch, is two interlinked pieces of machinery having a dryer and after-cooler. The dryer and after-cooler operate on a three-hour cycle time, so it became necessary to accumulate three washer cycles of cleaned feathers in a holding silo for a single charge into the dryer/after-cooler. The dryer employs ambient air heated to 130° C., and turbulent air flow to achieve the desired dryness, which approaches 1% moisture in the product. The after-cooler employs the same concept as the dryer, except that turbulent air is employed to reduce the cleaned feather temperature to 40-50° C. The cleaned and dried feathers were allowed to reach ambient temperature.

The particle size of the feather was reduced by a pre-grinder manufactured by Security Engineered Machinery Co. of Westboro, Mass. The pre-grinder reduced the feather stock to smaller pieces, partially removed the fiber from the quill, and produced particle sizes up to ⅜ inches long. Next, the particles were subjected to a shearing knife mill manufactured by Fitzpatrick Co. of Elmhurst, Ill. The mill completes the separation, and reduces the quill size to less than 0.42 mm and fiber that is ½ to 1 mm long. The resultant mixture was about 50% quill and 50% fiber. To separate the fiber from the quill, the separator illustrated in FIG. 3B of U.S. Pat. No. 5,705,030 was employed.

Predetermined quantities of feather fiber from above were added in 100 ml of the batch test solution to make a slurry and shaken for about 2 hours. After contact, the slurry was filtered and the supernatant was analyzed for Sr. The results are listed below in Table 3.

TABLE 3
Sr Removal from Test Solution Results

| Feather, mg | Initial Sr, ppb | Final Sr, ppb | % Sr Removal |
|---|---|---|---|
| 0 | 928 | — | NA |
| 10 | 928 | 599 | 36 |
| 50 | 928 | 150 | 84 |
| 100 | 928 | 363 | 60 |

It can be seen that the fiber was able to remove about 80% of the Sr from an alkaline solution.

### Example 2

The feather material from Example 1 was then tested at a lower initial concentration to measure the performance of the material. It is well known that adsorbent performance is based on the initial concentration. Results age listed below in Table 4.

TABLE 4
Sr Removal from Lower Concentration Test Solution

| Feather, mg | Initial Sr, ppb | Final Sr, ppb | % Sr Removal |
|---|---|---|---|
| 0 | 92.8 | — | NA |
| 5 | 92.8 | 13 | 86 |
| 10 | 92.8 | 30 | 68 |
| 20 | 92.8 | 20 | 78 |

It can be seen that the feather material continued to pick-up between about 70 to 80% Sr.

### Example 3

It was decided to try to increase the adsorption of the feather material by subjecting it to ultrasonic treatment (UST). Five grams of feather material from Example 1 was soaked in 100 mL of water at pH 12. The slurry was then exposed to ultrasonic treatment at 40 KHz for 40 seconds. The ultrasonically pretreated material was then filtered, washed, and dried. The dried material was ground in a vibratory mill for 10 minutes. This material was compared to milled product without ultrasonic treatment for Sr adsorption. Results are listed in Table 5.

TABLE 5
Effect of Ultrasonics on Sr Removal (Initial Sr at 92.8 ppb)

| Feather, mg | UST (y/n) | Final Sr, ppb | % Sr Removal |
|---|---|---|---|
| 2 | y | 27 | 71 |
| 2 | n | 28 | 70 |
| 4 | y | 27 | 71 |
| 4 | n | 27 | 71 |
| 6 | y | 27 | 71 |
| 6 | n | 27 | 71 |
| 8 | y | 10 | 89 |
| 8 | n | 27 | 71 |
| 10 | y | 18 | 81 |
| 10 | n | 26 | 72 |

It is evident that, at heavier dosages of feather fiber, the ultrasonic treatment of the feather fiber has an impact on the adsorption of Sr at higher loadings of feather fiber in the test bath.

### Example 4

Cesium was tested for uptake by the feather fiber of Example 1. The test solutions were prepared using a 1000 ppm standard solution of cesium and the alkali waste liquid of Example 1. Different amounts of feather fiber were prepared as in the strontium removal in Table 4 above. The treated feather fiber was contacted with a Cs solution diluted to 100 ppb and 100,000 ppb, respectively. The feather fiber was left in the shaking test solutions for 2 hours and then filtered. Results are presented in Table 6 and indicate that Cs is readily adsorbed by the feather fiber.

TABLE 6
Adsorption Results at Various Initial Concentrations of Cs

| Feather, mg | Initial Cs, ppb | Final Cs, ppb | % Cs Removal |
|---|---|---|---|
| 2 | 100 | 8 | 92 |
| 4 | 100 | 6 | 94 |
| 6 | 100 | 8 | 92 |
| 8 | 100 | 7 | 93 |
| 10 | 100 | 6 | 94 |
| 50 | 100,000 | 575 | 99 |
| 50 | 100,000 | 619 | 99 |
| 100 | 100,000 | 564 | 99 |
| 100 | 100,000 | 587 | 99 |
| 200 | 100,000 | 117 | 100 |
| 200 | 100,000 | 609 | 99 |
| 400 | 100,000 | 564 | 99 |
| 400 | 100,000 | 609 | 99 |
| 1000 | 100,000 | 621 | 99 |
| 1000 | 100,000 | 599 | 99 |

### Example 5

A test was conducted to determine the weight loss that occurred when the feather fiber was soaked in the alkaline pH solution at an elevated temperature. It was expected that the fiber would essentially dissolve in the environment. A known amount of feather fiber of Example 1 was weighed and dried to remove all moisture. It was added to the DOE suggested sludge of Example 1 at 60° C. and allowed to circulated for 2 hours. It was then removed, washed, dried, and weighed. Percent weight loss was calculated. It was found that the as-received feather fiber had a moisture content of about 6%. The weight loss was measured after soaking at ambient and at elevated temperature for 2 hours. The weight loss was 0% at ambient and only 8% at elevated temperature. This was unexpected because generally raw feather is unstable at an elevated temperature and proteins tend to have extremely poor alkali resistance.

### Example 6

### Experiments with Various Metals

Lead

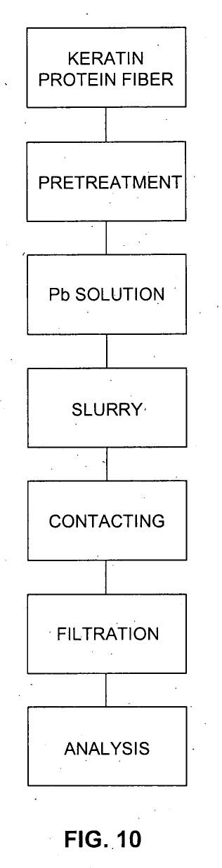

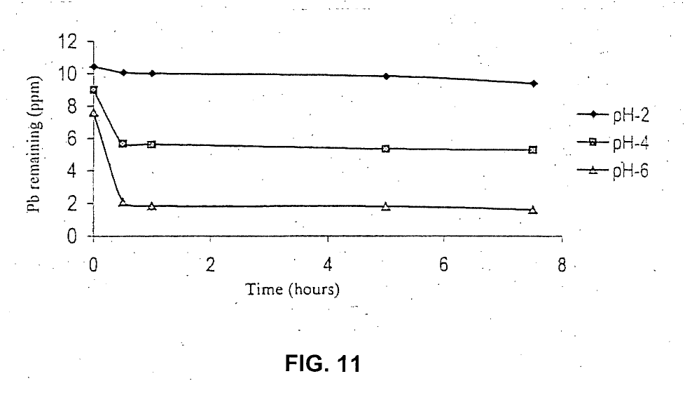

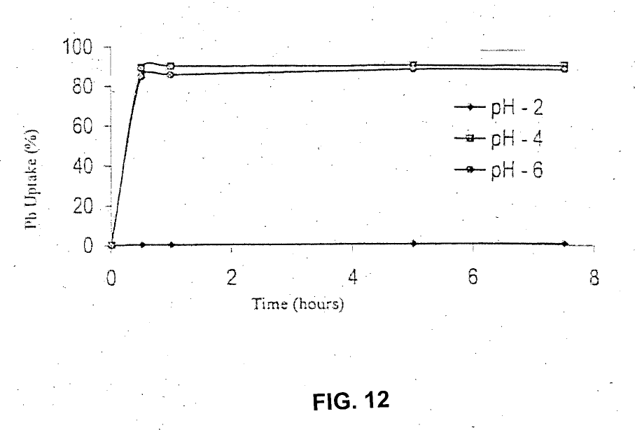

The adsorption of lead onto different amounts of keratin protein fibers as used above as a function of time and pH is shown in FIGS. 11-12. Batch adsorption was conducted using the procedure described in FIG. 10; this was substantially the same as shown above in FIG. 1. As can be seen for increasing pH and time, lead uptake increased for different additions of keratin protein fibers. Lead uptake was highest at pH 6 and equilibrium adsorption was accomplished within 15 minutes. Lead adsorption increased with an increase in keratin protein fiber addition.

Copper

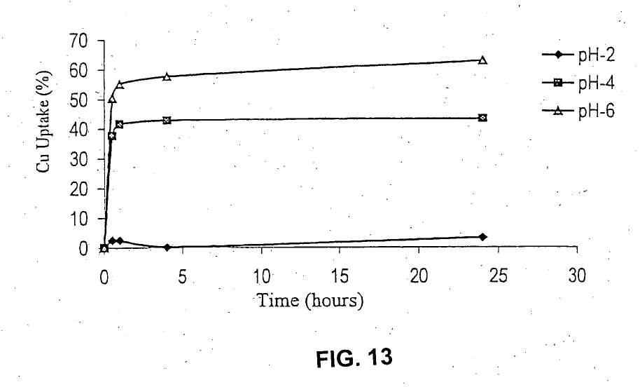

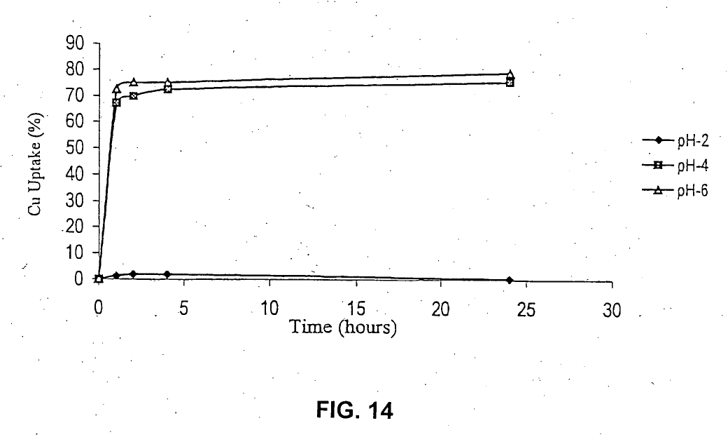

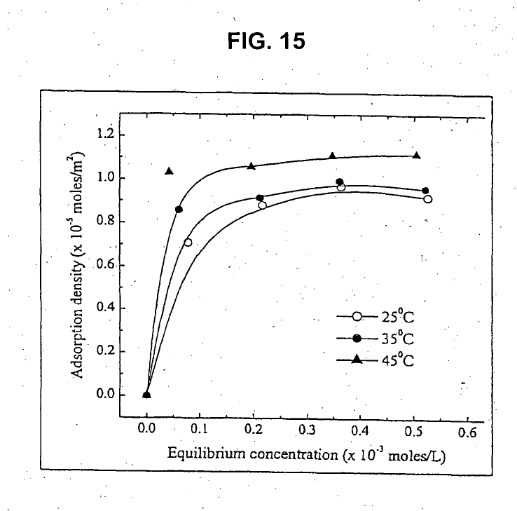

The adsorption of copper onto keratin protein fibers for additions of different quantities of keratin protein fibers is shown in FIGS. 13-15, depicting the effects of time and pH. In FIG. 13, 0.2 g of keratin protein fiber per 100 ml of solution was used with copper at an initial concentration of 10 ppm. In FIG. 14, 1.0 g of keratin protein fiber per 100 ml of solution was used. It can be seen that by increasing pH the adsorption of copper increases. An equilibrium adsorption was accomplished after 30 minutes. Adsorption also increased by increasing the addition of keratin protein fibers. However, at acidic pH (pH<3) very little copper uptake was observed. Experiments were not conducted above pH 6 due to the precipitation of copper oxide at such pH values. Copper adsorption increased with an increase in temperature as can be seen from the Langmuir adsorption isotherm (FIG. 15) at 25° C., 35° C., and 45° C. It was also noted that adsorbed metals could be removed (desorption) from the fibers by washing with acidic solution; 99% of the copper that was adsorbed was desorbed from the fiber by washing with dilute hydrochloric acid at pH 1.2. Results of desorption are shown in Table 7; 66% of the copper was desorbed at pH 1.45, as compared with 65.6% at pH 2.00. This shows that it is possible to remove and concentrate copper; at the same time; the keratin protein fibers can be reused. The adsorption-desorption nature of keratin fiber is summarized in Table 8.

TABLE 7
DESORPTION OF COPPER FROM KERATIN
PROTEIN FIBER

| Amount | | | | | | |
|---|---|---|---|---|---|---|
| of Keratin | | | | | | |
| Protein | | | | Cu | Cu | |
| Fiber per | | Copper | | Adsorbed, | Desorbed, | |
| 100 ml of | | Concentration, | | mg/g of | mg/g of | Cu |
| Solution, | Initial | ppm | | Keratin | Keratin | Desorbed, |
| g | pH | Initial | Final | Protein | Protein | % |
| 0.10 | 2.00 | 0.0 | 2.271 | 3.46 | 2.271 | 65.63 |
| 0.15 | 1.45 | 0.0 | 2.131 | 2.77 | 1.421 | 66.26 |

TABLE 8
ADSORPTION-DESORPTION BEHAVIOR OF
COPPER ON KERATIN PROTEIN FIBER

| | | | Copper Desorbed; mg/g |
|---|---|---|---|
| Process | pH | Copper Adsorbed, mg/g Fiber | Fiber |
| Adsorption | 5.4 | 0.60 | — |
| Desorption | 1.2 | — | 0.594 |

Cadmium

The biosorption of cadmium from a synthetic solution was conducted at a different pH. Results obtained with 0.2 g and 1.0 g of keratin protein fibers are shown in Table 9. Oh the basis of previous test work, conditioning was maintained for 30 minutes. Cadmium uptake was high at pH 8.3. By increasing the addition of keratin protein fibers, the removal efficiency of cadmium increased. Keratin protein fiber is a good adsorbent of cadmium, which remains ionized in solutions from acidic pH up to pH 8.5. Adsorption is more pH dependent than time dependent; the higher the pH, the greater the loading.

TABLE 9
BIOSORPTION OF CADMIUM ONTO KERATIN
PROTEIN FIBERS WITH 1-HOUR
CONTACT TIME

| | Amount | | | | | | |
|---|---|---|---|---|---|---|---|
| | of Keratin | | | | | | Mg of Cd |
| | Protein | | | | | | Adsorbed |
| | Fibers | | | | | | per |
| | per | | | | | | Gram of |
| | 100 ml of | | Concentration, | | Solution | Cd | Keratin |
| Exp | Solution | Initial | ppm | | Volume, | Uptake, | Protein |
| # | 1 g | pH | Initial | Final | ml | %° | Fiber |
| 42-1 | 0.2 | 2 | 8.24 | 8.66 | 100 | 0 | 0 |
| 42-2 | 0.2 | 4 | 8.14 | 6.28 | 100 | 22.85 | 0.93 |
| 42-3 | 0.2 | 6.5 | 7.93 | 4.79 | 100 | 39.59 | 1.57 |
| 42-4 | 0.2 | 8.3 | 7.46 | 2.82 | 100 | 62.20 | 2.32 |
| 45-1 | 1.0 | 2 | 8.24 | 9.02 | 100 | 0 | 0 |
| 45-2 | 1.0 | 4 | 8.14 | 2.28 | 100 | 71.99 | 0.59 |
| 45-3 | 1.0 | 6.5 | 7.93 | 1.92 | 100 | 75.79 | 0.60 |
| 45-4 | 1.0 | 8.3 | 7.46 | 1.01 | 100 | 86.46 | 0.64 |

Mercury

Removal of mercury from synthetic solutions with keratin protein fibers is given in Table 10. The maximum uptake of mercury occurs at pH 2.0. It was noted that 98% of HG can be removed at that pH. Hg loading is around 4 mg/g. Unlike other metals such as Cu and Pb, the uptake for Hg is high at pH 2.0. Almost all mercury present in the solution is removed.

TABLE 10
BIOSORPTION OF MERCURY ONTO KERATIN
PROTEIN FIBERS WITH 30-MINUTE
CONTACT TIME

| | Amount of | | | | | |
|---|---|---|---|---|---|---|
| | Protein | | | | | |
| | Keratin | | | | | |
| | Fibers per | | | | | Mg of Hg |
| | 100 ml of | | Concentration, | | Hg | Adsorbed per |
| Exp | Solution | Initial | ppm | | Uptake, | Gram of Keratin |
| # | 1 g | pH | Initial | Final | %° | Protein Fiber |
| 47-1 | 0.2 | 2.0 | 10.00 | 1.27 | 87.25 | 4.362 |
| 47-2 | 0.2 | 3.9 | 10.00 | 5.95 | 40.50 | 2.025 |
| 47-3 | 0.2 | 6.1 | 10.00 | 8.98 | 10.20 | 0.510 |
| 47-4 | 0.2 | 8.1 | 10.00 | 6.40 | 0 | 0 |
| 51-1 | 1.0 | 2.0 | 10.00 | 0.29 | 97.06 | 0.971 |
| 51-2 | 1.0 | 3.9 | 10.00 | 4.43 | 55.69 | 0.557 |
| 51-3 | 1.0 | 6.1 | 10.00 | 6.39 | 36.05 | 0.360 |
| 51-4 | 1.0 | 8.1 | 10.00 | 7.27 | 27.29 | 0.273 |

Zinc

Removal of zinc from a synthetic zinc solution is given in Table 11. At pH 2.0, no zinc was removed, but by increasing pH, Zn removal increased. At pH 8.3 almost 90% of zinc could be removed. It should be noted that at pH 8.3, some Zn could be precipitated as zinc hydroxide.

TABLE 11
BIOSORPTION OF ZINC ONTO KERATIN
PROTEIN FIBERS WITH 1-HOUR
CONTACT TIME

| | Amount of | | | | | Mg of |
|---|---|---|---|---|---|---|
| | Keratin Protein | | | | | Zn Adsorbed |
| | Fibers per | | Concentration, | | Zn | per Gram |
| | 100 ml of | Initial | ppm | | Uptake, | of Keratin |
| Exp # | Solution | pH | Initial | Final | %° | Protein Fiber |
| 30-1 | 0.2 | 2.0 | 8.76 | 9.08 | 0 | 0 |
| 30-2 | 0.2 | 4.0 | 8.41 | 7.04 | 16.29 | 0.86 |
| 30-3 | 0.2 | 6.5 | 8.15 | 6.07 | 25.52 | 1.04 |
| 30-4 | 0.2 | 8.3 | 3.97 | 0.35 | 91.18 | 1.81 |
| 34-1 | 1.0 | 2.0 | 8.76 | 10.1 | 0 | 0 |
| 34-2 | 1.0 | 4.0 | 8.41 | 5.67 | 32.58 | 0.27 |
| 34-3 | 1.0 | 6.5 | 8.15 | 4.95 | 39.26 | 0.32 |
| 34-4 | 1.0 | 8.3 | 3.97 | 0.53 | 86.64 | 0.34 |

Chromium (Cr⁺⁶ species)

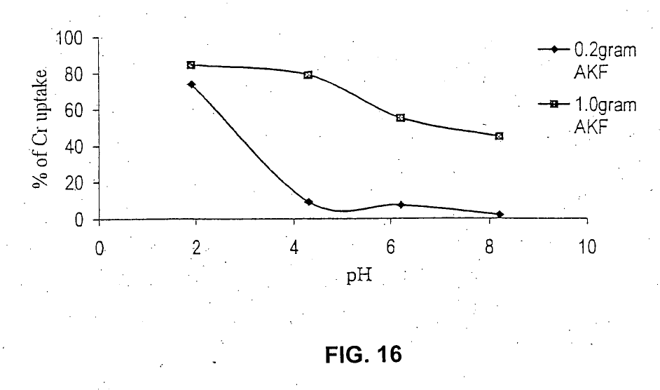

Removal of chromium (Cr⁺⁶ species) from synthetic chromate solutions is given in FIG. 16 as a function of pH for two different additions of keratin protein fibers. It was noted that Cr⁺⁶ uptake was high at low pH, i.e., pH 2.0. At this pH the predominant chromium species was HCrO₄⁻ instead of CrO₄ ⁻². Nevertheless CrO₄⁻² can be removed at high pH with the addition of a higher amount of keratin protein fibers. The difference in chromium removal at two keratin protein fiber additions may be due to the mixing and/or initial concentration of keratin protein fibers. The removal of chromium by keratin protein fibers at different pH values is also shown in Table 12.

TABLE 12
REMOVAL OF CHROMIUM BY KERATIN
PROTEIN FIBER AT DIFFERENT pH VALUES

| Initial pH | Chromium Uptake, %^{a} |
|---|---|
| 1.9 | 84.51 |
| 4.3 | 78.74 |
| 6.2 | 54.85 |
| 8.2 | 44.69 |

^{a}Keratin fiber used at 0.5 g/100 mL of solution.

Nickel

The adsorption of nickel onto keratin protein fibers was determined as a function of pH and of different amounts of keratin protein fibers. Different amounts of keratin protein fibers were added to 100 ml of the solution containing 2.2 to 2.4 ppm nickel. The samples were subjected to different mixing times, i.e., 30 minutes, 1.5 hours, and 3.5 hours, and then filtered. The filtrate was analyzed for nickel. Results are given in Table 13. The nickel uptake was around 30-35% at pH 6.2. It can be established from recent findings and other research results that nickel uptake onto the biomass is difficult.

TABLE 13
BIOSORPTION OF NICKEL ONTO
KERATIN PROTEIN FIBERS

| | |
|---|---|
| Initial | Concentration, ppm |

| pH | Initial | Final | Nickel Uptake, % |
|---|---|---|---|
| 1.98 | 2.24 | 2.17 | 3.13 |
| 3.71 | 2.51 | 2.18 | 13.15 |
| 6.12 | 2.40 | 1.65 | 31.25 |
| 1.98 | 2.24 | 2.20 | 1.79 |
| 3.71 | 2.51 | 1.82 | 27.50 |
| 6.12 | 2.40 | 1.47 | 38.25 |

Mixed Metals

Experiments were conducted with two different combinations of mixed metals as follows:

(1) A solution containing 2 ppm of Cu, Pb, and Hg was prepared at three different pH values, i.e., 1.91, 5.49, and 5.89. Keratin protein fibers (30 mg) were added to each solution. The solutions were mixed for one hour and then filtered. The filtrates were analyzed for Cu, Pb, and Hg. Results are given in Table 14. As can be seen, Pb removal was almost 100% o, and Hg removal more than 90% between pH 4.5-6.0. Cu removal was around 62% at pH 6.0. This experiment shows that mixed metals can be removed by selecting an appropriate pH. It can be concluded that in this mixed metals solution, the uptake was in the following order: Pb>Hg>Cu. In general, removal of metal cations from solution by keratin protein fiber is more efficient with metals with higher atomic weights. At the same time mercury (although highest in atomic weight) forms an anionic complex in solution, and thus shows better adsorption at lower pH, unlike cations such as Pb+².

TABLE 14
REMOVAL OF COPPER, LEAD, AND MERCURY FROM
MIXED METAL SOLUTION BY KERATIN PROTEIN FIBERS

| | % Metals Removed^{a} | | |
|---|---|---|---|
| pH | Cu | Pb | Hg |
| 1.9 | 0 | 0 | 97.6 |
| 4.5 | 56.2 | 100 | 92.3 |
| 5.9 | 62.1 | 100 | 89.6 |

^{a}Initial metal concentration at 2 ppm; keratin protein fibers used at 0.3 g/100 ml of solution.

(2) Another solution containing around 2 ppm of Cu, Pb, Zn, Cd, and Ni was prepared at four different pH values, i.e., 4.25, 5.53, 5.72, and 6.81. Keratin protein fibers (20 mg) were added to each of the solutions. The solutions were mixed for 2.5 hours and then filtered. The filtrates were analyzed for each of the above metals. The results are given in Table 15. It was seen that at pH 6.81, the adsorption was around 54% for Cu, 97% for Pb, 53% for Cd, 22% for Zn, and 14% for Ni. The uptake is in the following order: Pb>Cu>Cd>Zn>Ni.

TABLE 15
REMOVAL OF COPPER, LEAD, ZINC, CADMIUM
AND NICKEL FROM MIXED METAL SOLUTION
BY KERATIN PROTEIN FIBERS

| | % Metals Removed^{a} | | | | |
|---|---|---|---|---|---|
| pH | Cu | Pb | Zn | Cd | Ni |
| 4.25 | 38.2 | 69.7 | 0 | 9.7 | 10.9 |
| 5.33 | 45.6 | 78.6 | 2.1 | 14.5 | 7.0 |
| 5.72 | 48.8 | 83.5 | 3.8 | 17.0 | 6.1 |
| 6.81 | 53.4 | 96.4 | 21.9 | 52.4 | 13.8 |

^{a}Initial metal concentration at 2 ppm; keratin protein fibers used at 0.3 g/100 ml of solution.

Uranium

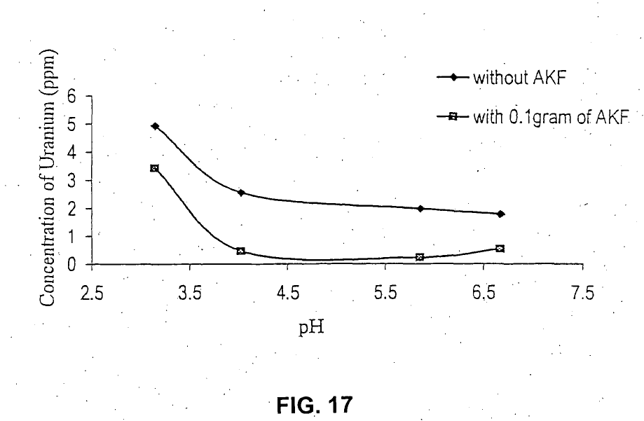

Uranium contamination is a serious problem in drinking water as well as in wastewater treatment. Several Department of Energy sites are contaminated with uranium, plutonium, strontium, cesium, and other radionuclides. The drinking water supply in one small town in Nevada is contaminated with uranium. Tests done with synthetic solutions have shown that a pH between about 4 and 5.5 is very effective for removal of uranium. These results are shown in Table 16. A synthetic uranium solution having an initial concentration of 3 ppm was used, with 0.1 g of keratin protein fiber per 100 mL of synthetic Removal of uranium as a function of pH with and without keratin protein fibers is shown in FIG. 17. Note that at pH 6, the uranium uptake is more than 88%.

TABLE 16
REMOVAL OF URANIUM FROM SYNTHETIC URANIUM
SOLUTION BY KERATIN PROTEIN FIBER

| pH | Uranium Uptake, %^{a} |
|---|---|
| 3.00 | 30.49 |
| 4.00 | 82.29 |
| 5.50 | 88.78 |
| 6.50 | 70.62 |

^{a}Keratin fiber used at 0.1 g/100 mL of solution; initial uranium concentration 3 ppm.

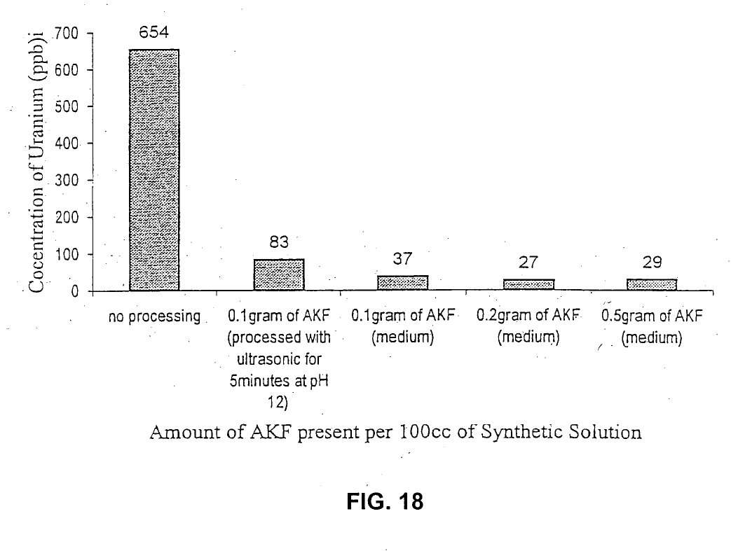

At the present time, the EPA drinking water standard for uranium concentration is 0.02 mg/L. Experiments were conducted to determine whether filters prepared from keratin protein fibers could decrease uranium concentration to meet the EPA standard. In another experiment, different amounts of keratin protein fibers were added to a solution containing 0.96 mg/L uranium. The results are given in FIG. 18 as a bar graph. With the addition of 1 g/L of keratin protein fibers, uranium concentration can be decreased to 0.02 mg/L.

### Example 7

### Effect of Particle Size

A study to show the effect of different particle sizes on lead uptake by different particle sizes of keratin protein fibers was conducted. Four different particle sizes of keratin protein fibers were used. These materials are identified in Table 17. In these tests 100 mg of keratin protein fibers was added to 100 mL of Pb solution containing 8.1 ppm lead at pH 6.1

TABLE 17
EFFECT OF KERATIN PROTEIN FIBER
PARTICLE SIZE ON LEAD UPTAKE

| Product | Approximate Size, | Surface Area, | Lead Uptake, |
|---|---|---|---|
| Identification | microns | m²/g | % ° |
| Coarse | 1000 × 5000 | 125 | 47.28 |
| Medium | 300 × 1000 | 120 | 54.19 |
| Fine | 200 × 500 | 120 | 54.44 |
| Ultra Fine | 15 | 120 | 65.80 |

### Example 8

### Effect of Alkaline Ultrasonic Treatment

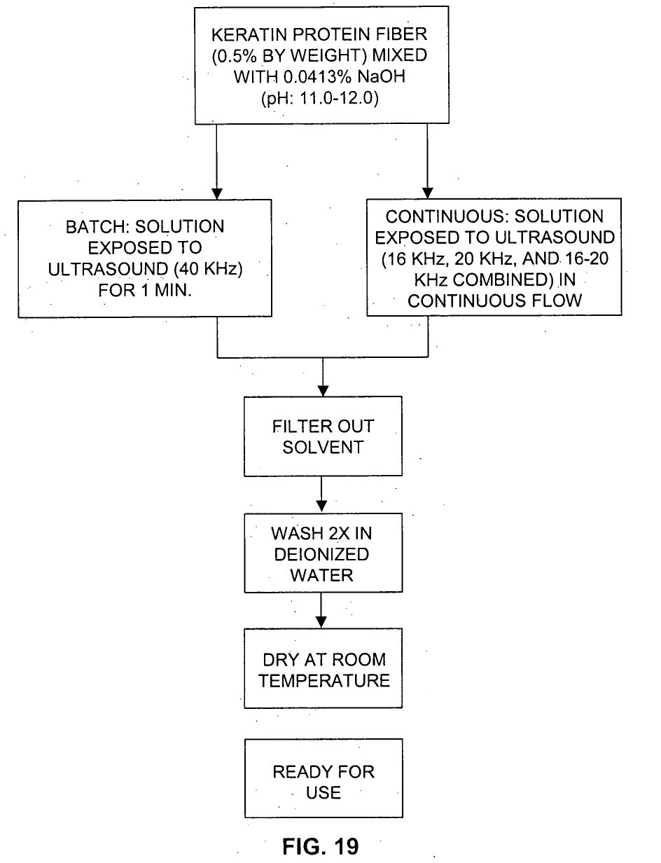

Ultrasound activation techniques have been applied for rupturing polymers, generating excited states, and disrupting cells. It has been observed that ultrasound increases surface area between reactants, accelerates dissolution, and renews the surface of a reactant or catalyst. In order to enhance the metal uptake, keratin protein fibers were treated at an alkaline pH range of 10-12 and then subjected to ultrasonic treatment. Specifically, a series of semicontinuous tests was conducted using a Nearfield Ultrasonic processor, manufactured by the Advanced Sonic Processing Company, New Jersey, USA. This device can be used to treat material at both single and dual frequencies, i.e., 16 KHz and 20 KHz. One hundred liters of slurry containing 0.5 wt % avian keratin protein fiber was conditioned at pH 11.75 for 10 minutes. After that, slurry containing the keratin fiber was passed into the ultrasonic device at a rate of 2 L/min. The ultrasonically processed material was filtered and washed several times until pH of the washing solution was around 6.5. The washed materials were dried, and tests were conducted to determine the efficiency of alkaline ultrasonic activation of keratin protein fibers for metal uptake. A flow diagram depicting the ultrasonic pretreatment procedure is given in FIG. 19.

Copper Adsorption

The keratin protein fibers after alkaline treatment was used to study copper uptake. The keratin protein fibers were exposed to ultrasonic treatment at pH 11.5 for three different times (30 seconds, 40 seconds, and 60 seconds). Also, one ultrasonic treatment of 60 seconds was done at the natural pH of water without alkaline exposure, and the results shown in Table 18. A distinct increase in adsorption of copper was observed in the case of alkaline ultrasonically treated material, as compared to material that had been ultrasonically treated at the natural pH of water or to untreated material. The results are suggestive of strong copper adsorption on alkaline ultrasonically treated keratin protein fibers.

TABLE 18
EFFECT OF ALKALINE ULTRASONIC TREATMENT
ON COPPER UPTAKE BY KERATIN PROTEIN FIBERS

| | | | | | | | Mg of Ca |
|---|---|---|---|---|---|---|---|
| Processing | | | | | | | Adsorbed |
| | Time of | | | Concen- | | | per Gram |
| pH of | Exposure to | | | tration, | | Cu | Keratin |
| Soaking | Ultrasound, | pH | | ppm | | Uptake, | Protein |
| Solution | sec | Initial | Final | Initial | Final | %° | Fibers^{a} |
| 11.00 | 30 | 5.56 | 6.38 | 9.10 | 5.486 | 39.71 | 3.61 |
| 11.00 | 40 | 5.56 | 6.51 | 9.10 | 4.569 | 49.79 | 4.53 |
| 11.00 | 60 | 5.56 | 6.41 | 9.10 | 5.128 | 43.65 | 3.97 |
| Natural | 60 | 5.56 | 5.71 | 9.10 | 7.890 | 13.30 | 1.21 |
| Water | | | | | | | |
| pH | | | | | | | |

^{a}Keratin protein fibers used at 0.1 g per 100 ml of solution.

Lead Adsorption

The uptake of lead after ultrasonic treatment of the keratin protein fibers is shown in Table 19. It can be seen that soaking at alkaline pH and ultrasonic treatment increased lead adsorption from 28.2% to almost 100%. For lead uptake, dual field activation (a combination of 16 and 20 KHz) was more effective than the use of a single frequency. It was observed that keratin protein fibers that had been subjected to 30-40 seconds of ultrasonic treatment showed good adsorption of lead and copper. Longer treatment times were not favorable for metal uptake.

TABLE 19
EFFECT OF ALKALINE ULTRASONIC TREATMENT
ON LEAD UPTAKE BY KERATIN PROTEIN FIBERS

| Processing | | | | | | |
|---|---|---|---|---|---|---|
| | Time of | | | | | |
| pH of | Exposure to | | | Concentration, | | Pb |
| Soaking | Ultrasound, | pH | | ppm | | Uptake, |
| Solution | sec | Initial | Final | Initial | Final | %° |
| 11.00 | 30 sec | 5.50 | 7.13 | 7.50 | 0.00 | 100.00 |
| 11.00 | 40 sec | 5.50 | 6.92 | 7.50 | 0.00 | 100.00 |
| 11.00 | 1 min | 5.50 | 6.95 | 7.50 | 0.10 | 98.67 |
| Natural | 1 min | 5.50 | 5.86 | 7.50 | 3.85 | 48.67 |
| Water pH | | | | | | |
| Natural | None | 5.56 | 5.59 | 9.20 | 6.69 | 28.28 |
| Water pH | | | | | | |
| 12.00 | 2.5 min | 5.56 | 6.61 | 9.20 | 2.64 | 71.30 |
| 12.00 | 5.0 min | 5.56 | 6.80 | 9.20 | 0.74 | 91.96 |

^{a}Keratin protein fibers used at 0.1 g per 100 ml of solution.

### Example 9

### Effect of Ultrasonic Frequency on Lead Uptake

A semi-continuous test was conducted using a Nearfield Ultrasonic Processor. This ultrasonic device has dual frequencies: i.e., 16 KHz and 20 KHz. A slurry of keratin protein fibers containing 0.5% by weight of keratin protein fibers was injected into the Nearfield Ultrasonic Processor. The results for lead adsorption with treated material are shown in Table 20. As can be seen, treatment with lower frequencies is more effective than treatment with higher frequencies in promoting lead uptake with keratin protein fibers. For example, lead uptake increased after 16 KHz treatment as compared with results obtained after 20 KHz treatment. This shows that ultrasonic treatment can be accomplished using frequencies between about 16 KHz to about 24 KHz, preferably at about 16 KHz. Similar results are summarized in Table 21.

TABLE 20
LEAD ADSORPTION RESULTS FOR ALKALINE
ULTRASONIC PROCESSING OF KERATIN PROTEIN
FIBERS USING NEARFIELD CONTINUOUS
ULTRASONIC PROCESSOR AT pH 11.56

| | | | Wt % of | | | |
|---|---|---|---|---|---|---|
| Ultra- | | | Keratin | | | |
| sonic | | Flow | Protein | Lead | | |
| Fre- | | Rate of | Fiber in | Concentration, | | Percentage |
| quency, | Power | Slurry, | Processed | ppm | | of Lead |
| KHz | Input, W | mL/min | Slurry | Initial | Final | Removed^{a} |
| None | — | 2200 | 0.5160 | 12.97 | 2.24 | 82.73 |
| 20 | 150 | 3000 | 0.7162 | 12.97 | 3.50 | 73.01 |
| 20 | 300 | 3000 | 0.6896 | 12.97 | 1.64 | 87.35 |
| 20 | 450 | 3600 | 0.6269 | 12.97 | 1.91 | 85.27 |
| None | — | 5000 | 0.3501 | 12.97 | 3.31 | 74.48 |
| 16 | 150 | 3750 | 0.6774 | 12.97 | 1.12 | 91.37 |
| 16 | 450 | 3450 | 0.6430 | 12.97 | 0.42 | 96.76 |
| None | — | 2500 | 0.4760 | 11.92 | 3.44 | 71.14 |
| 16 & 20 | 450 | 2700 | 0.6530 | 11.92 | 2.49 | 79.11 |
| 16 & 20 | 450 | 2800 | 0.4130 | 11.92 | 1.31 | 89.01 |
| 16 & 20 | 450 | 2750 | 0.5240 | 11.92 | 2.61 | 78.10 |

^{a}Keratin protein fibers used at 0.1 g per 100 ml of solution. The pH of the solution before adsorption was about 5.8 before adsorption and 6.10 after adsorption.

TABLE 21
EFFECT OF ALKALINE ULTRASONIC TREATMENT
ON LEAD REMOVAL WITH KERATIN PROTEIN FIBER

| Pretreatment | Lead Removal, % |
|---|---|
| None | 28 |
| Alkaline pH, no Ultrasound | 78 |
| Alkaline pH, Ultrasound 16 KHz | 85 |
| Alkaline pH, Ultrasound 20 KHz | 85 |
| Alkaline pH, Ultrasound 16 & 20 KHz | 90 |
| Alkaline pH, Ultrasound 24 KHz | 80 |

### Example 10

### Effect of Temperature on Adsorption of Copper onto Keratin Protein Fibers

From experiments performed for determining the effect of temperature on copper adsorption onto keratin protein fibers, it can be concluded that variation of temperature in the range of 20° C. to 50° C. did not have any significant effect on uptake. More importantly, the experiment demonstrated that the keratin protein fiber material remains stable at a temperature as high as 50° C. These results are shown in Table 22.

TABLE 22
EFFECT OF TEMPERATURE ON UPTAKE
OF COPPER ONTO KERATIN PROTEIN FIBERS

| | | | Concentration, | | |
|---|---|---|---|---|---|
| | pH | | ppm | | Copper |
| Temperature, ° C. | Initial | Final | Initial | Final | Uptake, %^{a} |
| 25 | 5.5 | 5.5 | 11.324 | 9.754 | 13.61 |
| 32 | 5.5 | 5.5 | 11.324 | 9.602 | 14.95 |
| 39 | 5.5 | 5.5 | 11.324 | 9.321 | 17.44 |
| 49 | 5.5 | 5.7 | 11.324 | 9.225 | 18.29 |

^{a}Keratin protein fibers used at 0.1 g per 100 ml of solution.

### Example 11

### Effect of High Pressure on Adsorption of Copper onto Keratin Protein Fibers

A study of the effect of high pressure on copper adsorption onto keratin protein fibers was carried out in a small autoclave of 500 ml holding capacity and capable of generating pressure up to 1000 psi. Experimental details are as given in the flow diagram (FIG. 1). The Cu²⁺ solution used (400 mL) was at a concentration of 10 ppm and a pH of 5.2. As a control, 100 mL of the solution with no keratin protein fiber was exposed to a 50 psi pressure for 1 hour. A second aliquot of 100 mL of the solution with 0.1 g of keratin protein fiber was exposed to, 50 psi for 1 hour. A third aliquot of the solution with 0.1 g of keratin protein fiber was kept in the small autoclave for 1 hour at atmospheric pressure. The effect of pressure on adsorption of Cu²⁺ was found to be very minimal, but the results indicated that a high pressure of about 50 psi may reduce the effectiveness of metal adsorption onto the keratin protein fiber material. The results are shown in Table 23.

TABLE 23
EFFECT OF PRESSURE ON UPTAKE OF
COPPER ONTO KERATIN PROTEIN FIBERS

| | | | Concentration, | | |
|---|---|---|---|---|---|
| | pH | | ppm | | Cu |
| Pressure, psi | Initial | Final | Initial | Final | Uptake, %^{a} |
| 50 | 5.5 | 5.2 | 8.95 | 8.88 | 0.78 |
| 50 | 5.5 | 5.2 | 8.95 | 8.12 | 9.27 |
| 0 | 5.5 | 5.2 | 8.95 | 8.49 | 5.14 |

^{a}Keratin protein fibers used at 0.1 g per 100 ml of solution.

### Example 12

### Continuous Column Adsorption

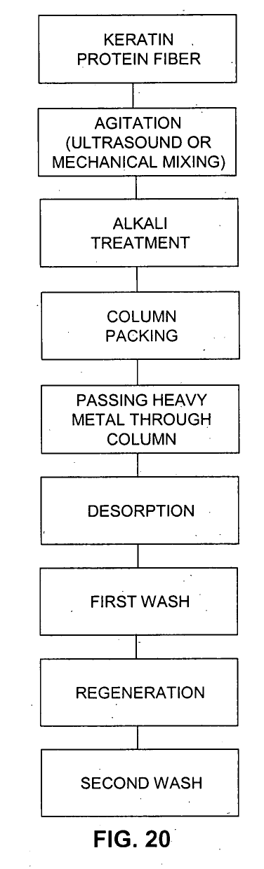

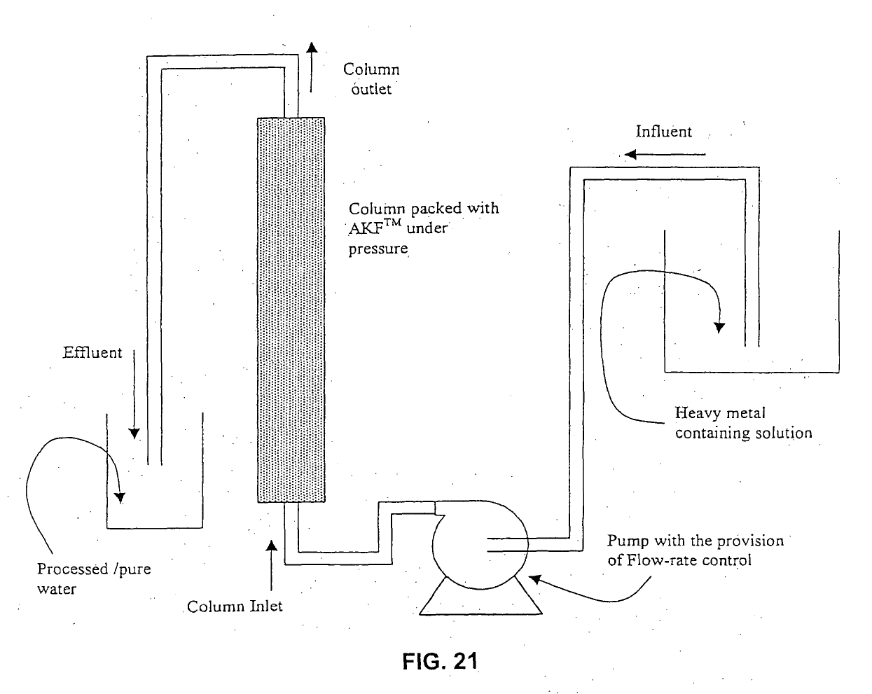

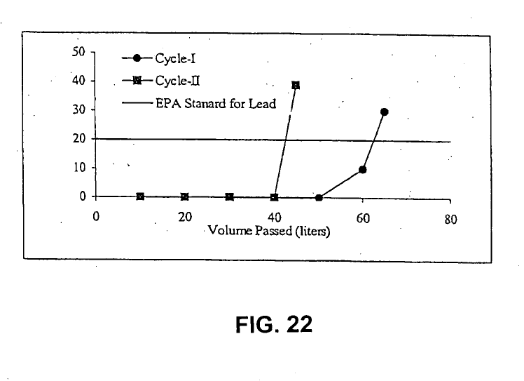

It was observed that mixing of keratin protein fiber in a small solution volume was difficult due to the extreme hydrophobic nature of the material. As a result, packed column tests were conducted to evaluate the effectiveness of A column adsorption test was conducted using alkaline ultrasonically processed keratin protein fiber material. The vertical column used had an internal diameter of 4 cm, a height of 57 cm, and a bed volume of approximately 800 ml, was packed under pressure with 135 g of the alkaline ultrasonically processed keratin protein fiber material. The column had the inlet at the bottom and the outlet at the top. The solution passed through the column under pressure and the flow rate was maintained at 6.66 mL/min. The column operation cycle had the following stages: (1) adsorption; (2) desorption (by passing appropriate eluant, HCl in this case); (3) first-stage washing; (4) regeneration (by alkaline solution); and (5) second-stage washing. After second-stage washing the column was ready for the beginning of the next cycle. In the column test carried out with lead, 65 L of lead solution having initial concentration of 10 mg/L (ppm) was purified to meet the EPA standard of 20 μg/L (ppb) in the first operation cycle and 40 L of the same solution were purified (meeting EPA standard) in the second operation cycle. A flow chart of the column adsorption scheme is shown in FIG. 20. A schematic diagram of the continuous column adsorption scheme is shown in FIG. 21. The results are shown in FIG. 22. These results show that a fixed quantity of the processed keratin fiber can be used in columns for multiple adsorption/desorption cycles, purifying large volumes of heavy-metal-contaminated water.

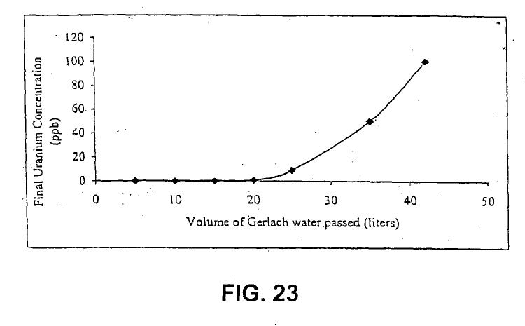

Similar column adsorption experiments were conducted on drinking water containing naturally-occurring uranium from the town of Gerlach, Nevada. Water samples from Gerlach were collected. The initial concentration of uranium was 75 ppb. The drinking water standard for uranium is 30 ppb. In order to establish the feasibility of removing uranium with column adsorption by keratin protein fiber, a packed column test was performed by passing 30 liters of water through a column containing 135 grams of keratin fiber. FIG. 23 is a graph showing the concentration of uranium in the effluent as a function of volume of water passed through the column. As can be seen, 25 liters of water can be treated before a breakthrough occurs. This test showed that a keratin protein fiber packed column can be used for the treatment of drinking water containing uranium.

A summary of removal efficiency of different metals using keratin protein fiber is given in Table 24. The data in Table 24 show that lead, copper, chromium, cadmium, and mercury can all be removed with high efficiency by adjusting the pH to an optimum value for each metal. It can also be possible to remove more than one metal by repeated treatments at the appropriate pH.

TABLE 24
SUMMARY OF REMOVAL EFFICIENCY OF DIFFERENT
METALS USING KERATIN PROTEIN FIBER

| Metal | Keratin Protein Fiber, | Optimum | Removal, |
|---|---|---|---|
| Species | g/100 mL of Solution | pH | % |
| Pb | 1.0 | 6.0-6.5 | 90 |
| Cu | 1.0 | 5.75-6.0 | 80 |
| Cd | 1.0 | 8.0 | 86 |
| Hg | 0.2 | 2.0 | 88 |
| Cr | 1.0 | 2.0 | 85 |

### REFERENCES

(1) H. Eccles, “Treatment of Metal-Contaminated Wastes: Why Select a Biological Process,” Biotopics 17: 462-465 (1999).

(2) Higgins, Pollution Prevention Handbook (CRC Press, 1995)

(3) F. Veglio & F. Beolchini, “Removal of Metals by Biosorption, a Review,” Hydrometallurgy 44: 301-316 (1997).

(4) R. A. A. Muzzarelli et al., Chitosin in Nature and Technology (Plenum Press, New York 1986).

(5) K. Suyama et al., “Biosorption of Precious Metal Ions by Chicken Feathers,” Appl. Biochem. Biotechnol. 57/58: 67-74 (1996).

(6) W. F. Schmidt et al., “Binding of Heavy Metal Ions to Fibers and Filters from Poultry Feathers,” Agricultural Research Service Report No. 78001, 1997.

(7) S. Ishikawa & K. Suyama, “Recovery and Refining of Au by Gold-Cyanide Ions Biosorption Using Animal Fibrous Proteins,” Appl. Biochem. Biotechnol. 70/72: 19-28 (1998).

As can be appreciated by those skilled in the art, the present invention provides a method of using keratin protein to adsorb metal ions in a way that is quick, efficient, and without the need for several processing steps. The present invention also allows the adsorption to be carried out at a high pH and high temperature, thereby providing greater flexibility in use. The present invention also provides a method in which the fibrous protein fiber, such as keratin protein fiber, can be recycled and reused to remove additional quantities of heavy metals from solutions.

It should be understood, of course, that the foregoing relates to preferred embodiments of the invention and that modifications may be made without departing from the spirit and scope of the invention as set forth in the following claims.

We claim:

1. A method of removing a heavy metal from a composition, comprising:
(a) providing a fibrous protein fiber;
(b) agitating the fibrous protein fiber;
(c) making a slurry of the agitated fibrous protein fiber;
(d) contacting the agitated fibrous protein fiber slurry with a composition containing a heavy metal ion or a heavy metal ion complex; and
(e) filtering a supernatant produced in step (d) to remove the heavy metal from the composition bound to fibrous protein in the supernatant.

2. The method of claim 1 wherein the fibrous protein of the fibrous protein fiber is selected from the group consisting of keratins, collagens, fibrins, and elastins.

3. The method of claim 2 wherein the fibrous protein is a keratin and the keratin is selected from the group consisting of α-keratins and β-keratins.

4. The method of claim 3 wherein the keratin is a β-keratin.

5. The method of claim 4 wherein the β-keratin is obtained from avian feathers.

6. The method of claim 5 wherein the avian feathers are obtained from a species selected from the group consisting of a chicken, a turkey, a duck, and a goose.

7. The method of claim 6 wherein the feathers are chicken feathers.

8. The method of claim 3 wherein the keratin is a naturally-occurring keratin.

9. The method of claim 4 wherein the keratin is a naturally-occurring keratin.

10. The method of claim 3 wherein the keratin is selected from the group consisting of keratin proteins obtained from wool, eggshell membrane, silk, spider web, animal hair, human hair, animal nail, human nail, animal skin, and their components.

11. The method of claim 1 wherein the heavy metal composition includes at least one metal ion selected from the group consisting of strontium, cesium, cadmium, copper, uranium, radium, gold, silver, platinum, vanadium, manganese, cobalt, chromium, lead, mercury, nickel, and zinc.

12. The method of claim 3 wherein the heavy metal composition includes at least one metal ion selected from the group consisting of strontium, cesium, cadmium, copper, uranium, radium, gold, silver, platinum, vanadium, manganese, cobalt, chromium, lead, mercury, nickel, and zinc.

13. The method of claim 1 wherein the heavy metal composition includes at least one ion complex selected from the chloro complexes of gold, silver, and platinum and the cyano complexes of gold, silver, and platinum.

14. The method of claim 3 wherein the heavy metal composition includes at least one ion complex selected from the chloro complexes of gold, silver, and platinum and the cyano complexes of gold, silver, and platinum.

15. The method of claim 1 wherein the concentration of the fibrous protein in the fibrous protein fiber slurry is from about 0.1 to about 10 mg/mL.

16. The method of claim 15 wherein the concentration of the fibrous protein in the fibrous protein fiber slurry is from about 0.5 to about 5 mg/mL.

17. The method of claim 3 wherein the concentration of the keratin in the keratin protein fiber slurry is from about 0.1 to about 10 mg/mL.

18. The method of claim 17 wherein the concentration of the keratin in the keratin protein fiber slurry is from about 0.5 to about 5 mg/mL.

19. The method of claim 3 wherein the size of the fibers of the keratin protein fibers is from about 0.01 mm to about 2 mm.

20. The method of claim 19 wherein the size of the fibers of the keratin protein fibers is from about 0.05 mm to about 1 mm.

21. The method of claim 1 wherein the fibrous protein fiber slurry is agitated by a method selected from the group consisting of ultrasound and mechanical mixing.

22. The method of claim 21 wherein the fibrous protein fiber slurry is agitated by ultrasound.

23. The method of claim 21 wherein the fibrous protein fiber slurry is agitated by mechanical mixing.

24. The method of claim 3 wherein the keratin protein fiber slurry is agitated by a method selected from the group consisting of ultrasound and mechanical mixing.

25. The method of claim 24 wherein the fibrous protein fiber slurry is agitated by ultrasound.

26. The method of claim 24 wherein the fibrous protein fiber slurry is agitated by mechanical mixing.

27. The method of claim 1 wherein the method further comprises ultraviolet irradiation of the fibrous protein fibers.

28. The method of claim 3 wherein the method further comprises ultraviolet irradiation of the keratin protein fibers.

29. The method of claim 1 wherein the composition is alkaline.

30. The method of claim 29 wherein the pH of the composition is from about 9 to about 14.

31. The method of claim 30 wherein the pH of the composition is from about 12 to about 14.

32. The method of claim 3 wherein the composition is alkaline.

33. The method of claim 32 wherein the pH of the composition is from about 9 to about 14.

34. The method of claim 33 wherein the pH of the composition is from about 12 to about 14.

35. The method of claim 1 wherein the step of contacting occurs at a pressure of not greater than about 10 psi.

36. The method of claim 3 wherein the step of contacting occurs at a pressure of not greater than about 10 psi.

37. The method of claim 1 wherein the step of contacting occurs at a temperature of between about 20° C. and about 90° C.

38. The method of claim 3 wherein the step of contacting occurs at a temperature of between about 20° C. and about 90° C.

39. The method of claim 1 wherein the heavy metal is initially present in the composition at a concentration of at least about 5 ppb.

40. The method of claim 3 wherein the heavy metal is initially present in the composition at a concentration of at least about 5 ppb.

41. The method of claim 39 wherein the heavy metal is strontium, and the strontium is initially present in the composition at a concentration of at least about 92.8 ppb.

42. The method of claim 40 wherein the heavy metal is strontium, and the strontium is initially present in the composition at a concentration of at least about 92.8 ppb.

43. The method of claim 39 wherein the heavy metal is cesium, and the cesium is initially present in the composition at a concentration of at least about 100 ppb.

44. The method of claim 40 wherein the heavy metal is cesium, and the cesium is initially present in the composition at a concentration of at least about 100 ppb.

45. The method of claim 6 wherein the method further comprises the step of pretreating the keratin protein to open micropores in the keratin protein and to increase the ability of sulfur atoms in the keratin protein to bond to strontium or cesium.

46. The method of claim 45 wherein the keratin protein comprises essentially a fiber portion of the avian feather.

47. The method of claim 46 wherein the keratin protein is produced by separating the fiber portion from a quill portion of the avian feather.

48. The method of claim 1 further comprising the step of vitrifying the supernatant.

49. The method of claim 48 wherein the step of vitrifying the supernatant is performed with a vitrification agent selected from the group consisting of cements, glasses, and polymer based binders.

50. The method of claim 3 further comprising the step of vitrifying the supernatant.

51. The method of claim 51 wherein the step of vitrifying the supernatant is performed with a vitrification agent selected from the group consisting of cements, glasses, and polymer based binders.

52. The method of claim 1 wherein the heavy metal is lead, and the step of contacting the agitated fibrous protein fiber slurry with the composition occurs at a pH of about 6.

53. The method of claim 1 wherein the heavy metal is copper, and the step of contacting the agitated fibrous protein fiber slurry with the composition occurs at a pH of about 6.

54. The method of claim 1 wherein the heavy metal is cadmium, and the step of contacting the agitated fibrous protein fiber slurry with the composition occurs at a pH of about 6.

55. The method of claim 1 wherein the heavy metal is mercury, and the step of contacting the agitated fibrous protein fiber slurry with the composition occurs at a pH of about 2.

56. The method of claim 1 wherein the heavy metal is zinc, and the step of contacting the agitated fibrous protein fiber slurry with the composition occurs at a pH of about 8.3.

57. The method of claim 1 wherein the heavy metal is chromium as Cr⁺⁶, and the step of contacting the agitated fibrous protein fiber slurry with the composition occurs at a pH of about 6.

58. The method of claim 1 wherein the heavy metal is nickel, and the step of contacting the agitated fibrous protein fiber slurry with the composition occurs at a pH of about 6.2.

59. The method of claim 1 wherein the heavy metal is uranium, and the step of contacting the agitated fibrous protein fiber slurry with the composition occurs at a pH of about 6.

60. The method of claim 3 wherein the heavy metal is lead, and the step of contacting the agitated keratin protein fiber slurry with the composition occurs at a pH of about 6.

61. The method of claim 3 wherein the heavy metal is copper, and the step of contacting the agitated keratin protein fiber slurry with the composition occurs at a pH of about 6.

62. The method of claim 3 wherein the heavy metal is cadmium, and the step of contacting the agitated keratin protein fiber slurry with the composition occurs at a pH of about 6.

63. The method of claim 3 wherein the heavy metal is mercury, and the step of contacting the agitated keratin protein fiber slurry with the composition occurs at a pH of about 2.

64. The method of claim 3 wherein the heavy metal is zinc, and the step of contacting the agitated keratin protein fiber slurry with the composition occurs at a pH of about 8.3.

65. The method of claim 3 wherein the heavy metal is chromium as Cr⁺⁶, and the step of contacting the agitated keratin protein fiber slurry with the composition occurs at a pH of about 6.

66. The method of claim 3 wherein the heavy metal is nickel, and the step of contacting the agitated keratin protein fiber slurry with the composition occurs at a pH of about 6.2.

67. The method of claim 3 wherein the heavy metal is uranium, and the step of contacting the agitated keratin protein fiber slurry with the composition occurs at a pH of about 6.

68. A method of removing a heavy metal from a composition, comprising:
(a) providing a keratin protein fiber;
(b) agitating the keratin protein fiber by a process selected from the group consisting of ultrasound and mechanical mixing;
(c) treating the keratin protein fiber with alkali at a pH of between about 9 to about 14;
(d) packing the agitated alkali treated keratin protein fiber into a column;
(e) passing the composition through the column under pressure to remove the heavy metal from the composition;
(f) desorbing adsorbed heavy metal from the column by treatment with an acid;
(g) washing the column for a first time;
(h) regenerating the column by passing alkali through the column; and
(i) washing the column for a second time.

69. The method of claim 68 wherein the keratin protein fiber is treated with alkali at a pH of from about 12 to about 14.

70. The method of claim 69 wherein the acid is HCl.

71. The method of claim 68 wherein the keratin is selected from the group consisting of α-keratins and β-keratins.

72. The method of claim 71 wherein the keratin is a β-keratin.

73. The method of claim 72 wherein the P-keratin is obtained from avian feathers.

74. The method of claim 73 wherein the avian feathers are obtained from a species selected from the group consisting of a chicken, a turkey, a duck, and a goose.

75. The method of claim 74 wherein the feathers are chicken feathers.

76. The method of claim 68 wherein the keratin is a naturally-occurring keratin.

77. The method of claim 68 wherein the keratin is selected from the group consisting of keratin proteins obtained from wool, eggshell membrane, silk, spider web, animal hair, human hair, animal nail, human nail, animal skin, and their components.

78. The method of claim 68 wherein the heavy metal composition includes at least one metal ion selected from the group consisting of strontium, cesium, cadmium, copper, uranium, radium, gold, silver, platinum, vanadium, manganese, cobalt, chromium, lead, mercury, nickel, and zinc.

79. The method of claim 68 wherein the heavy metal composition includes at least one ion complex selected from the chloro complexes of gold, silver, and platinum and the cyano complexes of gold, silver, and platinum.

80. The method of claim 68 wherein the size of the fibers of the keratin protein fibers is from about 0.01 mm to about 2 mm.

81. The method of claim 80 wherein the size of the fibers of the keratin protein fibers is from about 0.05 mm to about 1 mm.

82. The method of claim 68 wherein the heavy metal is initially present in the composition at a concentration of at least about 5 ppb.

83. The method of claim 68 wherein the heavy metal is strontium, and the strontium is initially present in the composition at a concentration of at least about 92.8 ppb.

84. The method of claim 68 wherein the heavy metal is cesium, and the cesium is initially present in the composition at a concentration of at least about 100 ppb.

85. The method of claim 68 wherein the step of passing the composition through the column under pressure occurs at a temperature of between about 20° C. and about 90° C.

86. The method of claim 68 wherein the step of passing the composition through the column under pressure occurs at a pressure of not greater than about 10 psi.

87. The method of claim 68 wherein the method further comprises the step of pretreating the keratin protein to open micropores in the keratin protein and to increase the ability of sulfur atoms in the keratin protein to bond to strontium or cesium.

88. The method of claim 68 wherein the keratin protein comprises essentially a fiber portion of the avian feather.

89. The method of claim 88 wherein the keratin protein is produced by separating the fiber portion from a quill portion of the avian feather.

90. The method of claim 68 wherein the heavy metal is lead, and the step of passing the composition through the column under pressure occurs at a pH of about 6.

91. The method of claim 90 wherein the composition has a lead concentration of less than about 20 ppb after being passed through the column.

92. The method of claim 68 wherein the heavy metal is copper, and the step of passing the composition through the column under pressure occurs at a pH of about 6.

93. The method of claim 68 wherein the heavy metal is cadmium, and the step of passing the composition through the column under pressure occurs at a pH of about 6.

94. The method of claim 68 wherein the heavy metal is mercury, and the step of passing the composition through the column under pressure occurs at a pH of about 2.

95. The method of claim 68 wherein the heavy metal is zinc, and the step of passing the composition through the column under pressure occurs at a pH of about 8.3.

96. The method of claim 68 wherein the heavy metal is chromium as Cr⁺⁶, and the step of passing the composition through the column under pressure occurs at a pH of about 6.

96. The method of claim 68 wherein the heavy metal is nickel, and the step of passing the composition through the column under pressure occurs at a pH of about 6.2.

97. The method of claim 68 wherein the heavy metal is uranium, and the step of passing the composition through the column under pressure occurs at a pH of about 6.

98. The method of claim 97 wherein the composition has a uranium concentration of less than about 30 ppb after being passed through the column.
